(19) United States
(12) Patent Application Publication
(10) Pub. No.: US 2003/0015952 A1
(43) Pub. Date: Jan. 23, 2003

(54) C type bulb center column construction

(76) Inventor: Chun-Teng Lee, Taipei City (TW)

Correspondence Address: CHUN-TENG LEE, P.O. BOX 7-820, TAIPEI, TW

(21) Appl. No.: 09/906,923

(22) Filed: Jul. 18, 2001

(51) Int. Cl. H01K 1/00; H01J 1/00; H01K 1/02

(52) U.S. Cl. 313/315; 313/326

(57) ABSTRACT

This invention relates to C type bulb center column construction., The main characteristic consists in a mass to combine the tie two lead wires, should combine central pivot tie of mass a the center tube present the cross shape, make two lead wires because of in the center tube however compartment two side end. Make the tungsten silk anti because of concentration by two the sides keep a safe space to let divide equally draw apart get anti is interlacing short, and the drubbing one construction do not share the space and then order the lamp turn down the heat energy to lift to increase the service life. This case differ early times center column depend on oviduct, center column composition piece complicated, manufacture to do not occupy the bigger space easily to wait for the defect, energy doubly life compliant reduction production process, promote the quality stability application capability.

### BACKGROUND OF THE INVENTION

1. Field of the Invention

This invention is related to One type of C type bulb center column construction, especially a mass to combine the tie two lead wires. Should combination mass center pivot tie the center tube present the cross shape, make two lead wires because of in the center tube however compartment two side end. Make the tungsten silk anti because of concentration by two the sides keep a safe space to let divide equally draw apart get anti is interlacing short, enter however energy doubly life compliant reduction production process, promote the quality stability application capability.

2. Description of he Prior Art

Combine according to the traditional C type bulb constitute, its bulb inside necessarily reach a the center column prop up the tungsten silk to provide to take place shining. This center column construction (STEM) necessarily have the center tube, oviduct, center column and conduct electricity the silk etc. one after another gradually after processing the formation semi-processed goods, progress tie connecting tungsten silk again and bulb housing fusion. Such labor concentrate oversee workers manufacture and many screw station process, substantially, produce capability anti good, the quality do not manage the rate of rejects easily higher—give rise to the cost higher-, do not match so ages economy condition. Another bulb compliant last compliant above module occupy housing inside equal space outside, because the glass of the oviduct contain lead. When spot lamp hour release the lead to measure to make the bulb easy living very hot engender the tungsten silk to turn down the life compliant, is however this etc. center column constitute compliant have improvement necessity.

### SUMMARY OF THE INVENTION

The main object of the present invention is to provide C type bulb center column construction, especially a mass to combine the tie two lead wires. Should combine central pivot tie of mass the center tube present the cross shape, make two lead wires because of in the center tube however compartment two side end. Can make the tungsten silk anti because of concentration by two side space ream divide equally draw apart get anti is interlacing short, enter however doubly life compliant reduction production process, promote the quality stability application capability for its characteristic.

Another object of the present invention is to provide C type bulb center column construction. Especially a rod mass pivot to match central center tube conduct and actions compartment lead wire two the sides carry to keep a safe space construction, far from it in the oviduct, center column composition anti easy complicated. Especially is reduction production the process decline low cost, assembly piece little do not share the space however quality stabilization application function effect.

Another feature of the present invention is to provide C type bulb center column construction. Especially this artistic constitute compliant because the non-oviduct include lead compliant, do not occupy the racuum space so, order the lamp heat energy release the lead to measure little, doubly service life lengthen characteristics effect.

### BRIEF DESCRIPTION OF THE DRAWINGS

FIG. 1 is a perspective view of the present invention;

FIG. 2 is this artistic center column two the sides carry it the lead wire keep a safe space construction chart;

FIGS. 3 and 4 are this artistic center column to constitute to compare with traditional center column chart.

### DETAILED DESCRIPTION OF THE PREFERRED EMBODIMENT

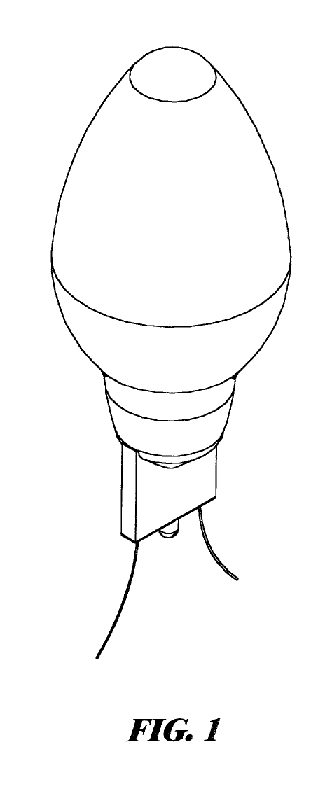

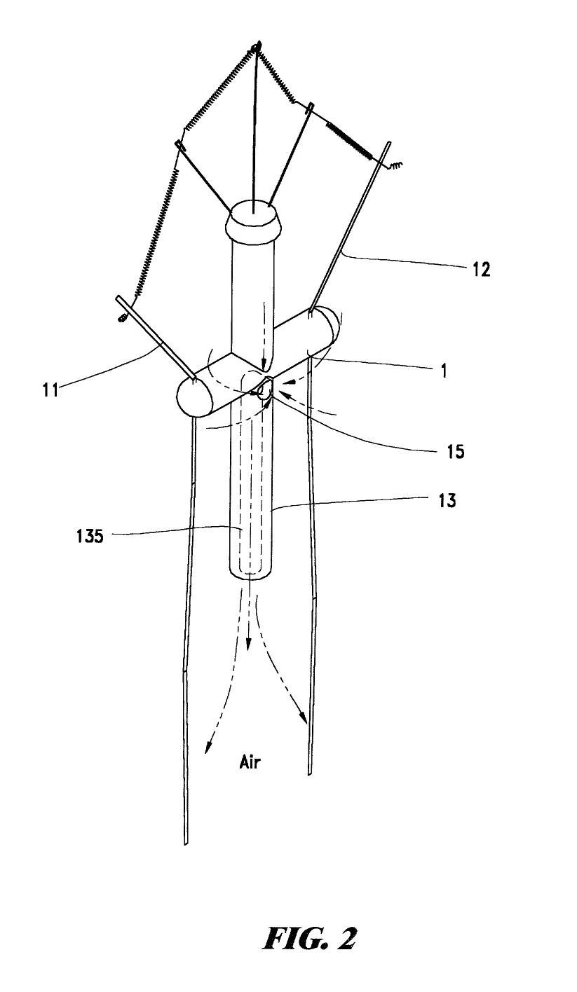

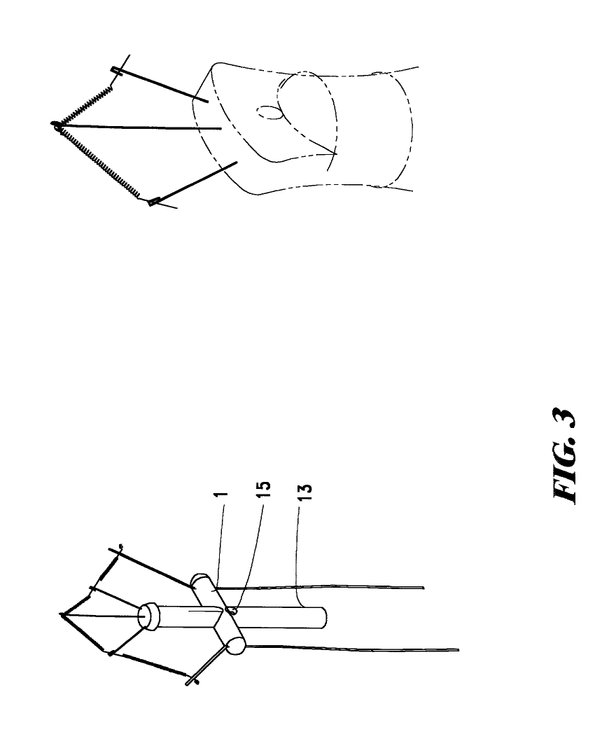

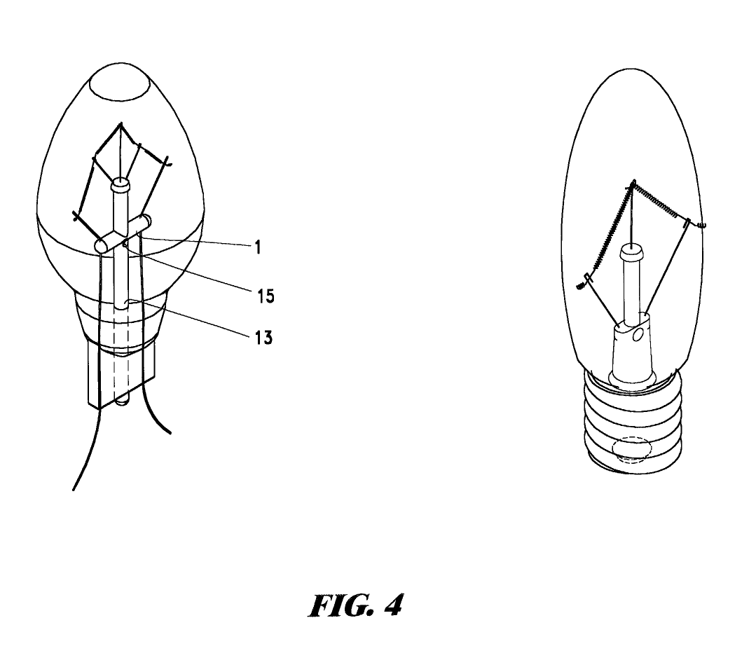

With reference to the drawings and in particular to FIGS. 1 through 4, one type of C type bulb center column construction of this artistic constitute. Is main with a mass combine the tie two lead wires 11, 12, its combinative mass 1 in center place pivot tie a center tube circle 13 become the shape of the cross, make the fusion in the mass body two side end it lead wire because of in the center tube circle however keep a safe space. Should combination the center tube unit of the mass center column have to establish an air current through hole 15 connect with each other center tube inside piping 135. Make the center column and bulb housing fusion integral whole, get center tube air current hole will housing inside will housing inside air discharge in outside end, and make the center column two lead wires direct pivot combination weld unit extention outside end connect two phase electrodes. This case effect is a center column two lead wires because of in the center tube however compartment two side end, make the tungsten silk anti because of concentration by two safe space of sides get anti is interlacing short. And the drubbing one construction do not share the space and then order the lamp turn down the heat energy to increase the service life. Energy doubly service life, reduction production process, promote the quality stability application capability.

I claim:

1. One type of C type bulb center column construction, combine the tie with a mass primarily two lead wires. Central potential pivot tie of its combinative mass a center tube circle cross shape, make the fusion in the mass body two side end lead wire because of in the center tube circle get the compartment keep a safe space, combine the mass center column center tube unit have to establish an air current through hole connect with each other center tube inside is its characteristic.
